(19) United States
(12) Patent Application Publication
(10) Pub. No.: US 2010/0080395 A1
(43) Pub. Date: Apr. 1, 2010

(54) CRYPTOGRAPHIC METHOD FOR A WHITE-BOX IMPLEMENTATION

(75) Inventors: Wilhelmus Petrus Adrianus Johannus Michiels, Eindhoven (NL); Paulus Mathias Hubertus Mechtildis Antonius Gorissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,922

(22) PCT Filed: Nov. 9, 2007
(86) PCT No.: PCT/IB2007/054565

§ 371 Date: May 14, 2009

(30) Foreign Application Priority Data
Nov. 17, 2006 (EP) 06124267.3

(51) Int. Cl. H04L 9/28; H04L 9/08; H04L 9/00

(52) U.S. Cl. 380/278; 380/28; 380/44

(57) ABSTRACT

A cryptographic method is implemented in a white-box implementation thereof. The method comprises applying a plurality of transformations (802) each replacing an input word by an output word, and applying a diffusion operator (804) to a concatenation of a plurality of the output words for diffusing information represented by the output words among the output words. A key (806) to the cryptographic method comprises information representing the diffusion operator. The diffusion operator satisfies a property that a change of one bit in an input to the diffusion operator corresponds to a change of more than one bit in an output of the diffusion operator.

### FIELD OF THE INVENTION

The invention relates to a cryptographic method for being implemented in a white-box implementation thereof.

### BACKGROUND OF THE INVENTION

The Internet provides users with convenient and ubiquitous access to digital content. The use of the Internet as a distribution medium for copyrighted content creates the compelling challenge to secure the interests of the content provider. In particular it is required to warrant the copyrights and business models of the content providers. Increasingly, consumer electronics (CE) platforms are operated using a processor loaded with suitable software. Such software may include the main part of functionality for rendering (playback) of digital content, such as audio and/or video. Control of the playback software is one way to enforce the interests of the content owner including the terms and conditions under which the content may be used. Where traditionally many CE platforms (with the exception of a PC and PDA) used to be closed, nowadays more and more platforms at least partially are open. In particular for the PC platform, some users may be assumed to have complete control over the hardware and software that provides access to the content and a large amount of time and resources to attack and bypass any content protection mechanisms. As a consequence, content providers must deliver content to legitimate users across a hostile network to a community where not all users or devices can be trusted.

Typically, digital rights management systems use an encryption technique based on block ciphers that process the data stream in blocks using a sequence of encryption/decryption steps, referred to as rounds. During each round, a round-specific function is performed. The round-specific function may be based on a same round function that is executed under control of a round-specific sub-key. For many encryption systems, the round function can be specified using mapping tables or look-up tables. Even if no explicit tables were used, nevertheless frequently tables are used for different parts of the function for efficient execution in software of encryption/decryption functions. The computer code accesses or combines table values into the range value of the function. Instead of distributing keys, that may be user-specific, it becomes more interesting to distribute user specific algorithms instead of keys for encryption or decryption algorithms. These algorithms, most often functions (mappings), have to be obfuscated (hidden) in order to prevent redesign or prohibit the re-computation of elements that are key-like. On computers, tables accompanied with some computer code often represent these functions.

Content providers must deliver content to legitimate users across a hostile network to a community where not all users or devices can be trusted. In particular for the PC platform, the user must be assumed to have complete control of the hardware and software that provides access to the content, and an unlimited amount of time and resources to attack and bypass any content protection mechanisms. The software code that enforces the terms and conditions under which the content may be used must not be tampered with. The general approach in digital rights management for protected content distributed to PCs is to encrypt the digital content, for instance DES (Data Encryption Standard), AES (Advanced Encryption Standard), or using the method disclosed in WO9967918, and to use decryption keys.

In relation to key handling, for playback a media player has to retrieve a decryption key from a license database. It then has to store this decryption key somewhere in memory for the decryption of the encrypted content. This leaves an attacker two options for an attack on the key. Firstly, reverse engineering of the license database access function could result in black box software (i.e., the attacker does not have to understand the internal workings of the software function), allowing the attacker to retrieve asset keys from all license databases. Secondly, by observation of the accesses to memory during content decryption, it is possible to retrieve the asset key. In both cases the key is considered to be compromised.

“White-Box Cryptography and an AES Implementation”, by Stanley Chow, Philip Eisen, Harold Johnson, and Paul C. Van Oorschot, in Selected Areas in Cryptography: 9th Annual International Workshop, SAC 2002, St. John's, Newfoundland, Canada, Aug. 15-16, 2002, referred to hereinafter as “Chow 1”, and “A White-Box DES Implementation for DRM Applications”, by Stanley Chow, Phil Eisen, Harold Johnson, and Paul C. van Oorschot, in Digital Rights Management: ACM CCS-9 Workshop, DRM 2002, Washington, DC, USA, Nov. 18, 2002, referred to hereinafter as “Chow 2”, disclose methods with the intend to hide the key by a combination of encoding its tables with random bijections representing compositions rather than individual steps, and extending the cryptographic boundary by pushing it out further into the containing application.

“Cryptanalysis of a White Box AES Implementation”, by Olivier Billet, Henri Gilbert, and Charaf Ech-Chatbi, in SAC 2004, LNCS 3357, pp. 227-240, 2005, referred to hereinafter as “Billet”, describes an attack against the obfuscated AES implementation proposed at SAC 2002 as a means to protect AES software operated in the white box context against key exposure. The paper explains how to extract the whole AES secret key embedded in such a white box AES implementation, with negligible memory and worst time complexity 2³⁰.

### SUMMARY OF THE INVENTION

It would be advantageous to have an improved cryptographic method. To better address this concern, in a first aspect of the invention a cryptographic method for being implemented in a white-box implementation thereof is presented that comprises applying a plurality of transformations each replacing an input word by an output word; and

applying a diffusion operator to a concatenation of a plurality of the output words for diffusing information represented by the output words among the output words; wherein a key to the cryptographic method comprises information representing the diffusion operator.

A white box implementation may comprise a network of look-up tables that are obfuscated by encoding their input and output. The inventors have recognized that the diffusion operator makes a white-box implementation of a cryptographic method relatively vulnerable to attacks. One way to reduce this vulnerability is to make it more difficult for the attacker to find out what diffusion operator is used in the white-box implementation. Making the diffusion operator a variable of the method by incorporating it into the key to the cryptographic method ensures that an attacker does not know a priori which diffusion operator is used. This way the attacker needs to discover more information to realize a successful attack. In particular some published attacks to white-box implementations are complicated by taking this precaution.

The diffusion operator does not respect word boundaries. This means that it propagates bit errors to a larger portion of the data. Other operations that are part of the cryptographic method, such as S-boxes, map word values to different word values. Here, a word has a limited number of bits, for example a word may be a 4-bit nibble, an 8-bit byte, or a 16-bit word. The number of bits in a word may be determined by the word size used in such S-boxes. The diffusion operator has an output that is larger than one word, for example two or four words. If the cryptographic method is a block cipher, usually the output word of the diffusion operator is not larger than one data block of the block cipher. In the example of AES, the S-boxes operate on 8-bit words, whereas the diffusion operator operates on 32-bit values, i.e. values comprising four 8-bit words. The block size of AES is 128 bits, which is larger than the size of the output of the diffusion operator. The information representing the diffusion operator includes sufficient information to uniquely identify the intended diffusion operator, for example the information can include the elements of a matrix operator or it can include a number of look-up tables that need to be used in the white-box implementation to implement the diffusion operator in conjunction with applicable input and output encodings.

In an embodiment, the diffusion operator satisfies a property that a change of one bit in an input to the diffusion operator corresponds to a change of more than one bit in an output of the diffusion operator.

A goal of the diffusion operator is to propagate the effect of a decryption error in a single bit to the other bits of the data block, in order to make the complete data block unusable. This also makes it more difficult to find the cryptographic key embedded in the white-box implementation. A minimum step to realize this property is to make sure that a bit error is propagated to more than one bit. Ways to find operators satisfying this property are known in the art. Ideally, if a linear diffusion operator is used, it is maximum distance separable. A change of at least one bit in one of the output words should result in a change of at least two of the output words by the diffusion operator (each of the at least two output words having at least one changed bit).

In an embodiment, the diffusion operator is a nonlinear operator.

Nonlinear diffusion operators make the attack more difficult.

In an embodiment,

an input of the diffusion operator is given by a sequence of k outputs of S-boxes, the output of each S-box being an n-bit value, where k and n are predetermined positive integer values,

an output of the diffusion operator represents a sequence of/inputs to non-linear output encodings of the white-box implementation, the input to each output encoding being an m-bit value, where l and m are predetermined positive integer values, and

the diffusion operator is a linear operator having a representation as an invertible matrix dividable into l rows of k submatrices of m×n elements, each row satisfying a property that a matrix formed by a concatenation of a first subset of the submatrices forming that row and a matrix formed by a concatenation of a second subset of the submatrices forming that row, the first subset and the second subset being disjunct, do not both have a rank of m.

A cryptographic method using the class of linear operators used in this embodiment is relatively difficult to break.

In an embodiment, the key comprises a representation of the invertible matrix.

This representation is an efficient way to represent a linear diffusion operator.

In an embodiment, the cryptographic method comprises a Rijndael method in which a MixColumns operator is replaced by the diffusion operator. In another embodiment, the cryptographic method is based on a Feistel method.

An embodiment comprises

an input for receiving a key, the key comprising information representing a diffusion operator; and

a white-box implementation of a cryptographic method, the cryptographic method comprising applying a plurality of transformations each replacing an input word by an output word; and applying the diffusion operator to a concatenation of a plurality of the output words for diffusing information represented by the output words among the output words.

In an embodiment, the key comprises one or more look-up tables representing the diffusion operator obfuscated with input and output encodings.

An embodiment comprises

a client comprising an input for receiving a key, the key comprising information representing a diffusion operator; the client further comprising a white-box implementation of a cryptographic method, the cryptographic method comprising applying a plurality of transformations each replacing an input word by an output word, and applying the diffusion operator represented by the information in the key to a concatenation of a plurality of the output words for diffusing information represented by the output words among the output words;

a server for applying a cryptographic method corresponding to the cryptographic method implemented in the client, in dependence on the key; and

means for generating the key.

### BRIEF DESCRIPTION OF THE DRAWINGS

These and other aspects of the invention will be further elucidated and described with reference to the drawing, in which

FIG. 1 is a diagram illustrating operations in a round of AES;

FIG. 2 is a diagram illustrating an example of obfuscating tables;

FIG. 3 is a diagram illustrating a round for a column in a white-box AES implementation;

FIG. 4 is a diagram illustrating mappings incorporated in a type Ia table;

FIG. 5 is a diagram illustrating mappings incorporated in a type II table;

FIG. 6 is a diagram illustrating mappings incorporated in a type III table;

FIG. 7 is a diagram illustrating mappings incorporated in a type IV table;

FIG. 8 is a diagram illustrating mappings incorporated in a type Ib table;

FIG. 9 is a flowchart illustrating processing steps;

FIG. 10 is a flowchart illustrating more processing steps;

FIG. 11 is a diagram illustrating an embodiment; and

FIG. 12 is a diagram illustrating an embodiment.

### DETAILED DESCRIPTION OF EMBODIMENTS

AES is a block cipher with a block size of 128 bits or 16 bytes. The plaintext is divided in blocks of 16 bytes which form the initial state of the encoding algorithm, and the final state of the encoding algorithm is the ciphertext. To conceptually explain AES, the bytes of the state are organized as a matrix of 4×4 bytes. AES consists of a number of rounds. Each round is composed of similar processing steps operating on bytes, rows, or columns of the state matrix, each round using a different round key in these processing steps.

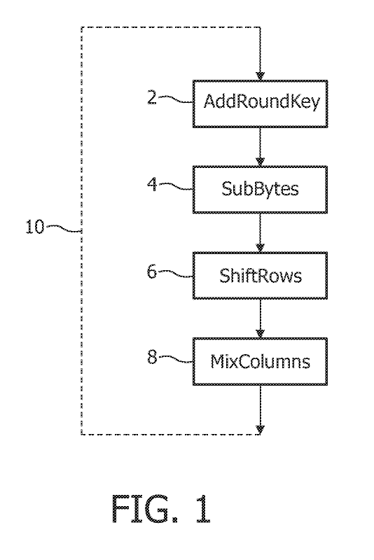

FIG. 1 illustrates some main processing steps of a round of AES. The processing steps include:

AddRoundKey 2—each byte of the state is XOR'ed with a byte of the round key.

SubBytes 4—A byte-to-byte permutation using a lookup table.

ShiftRows 6—Each row of the state is rotated a fixed number of bytes.

MixColumns 8—Each column is processed using a modulo multiplication in GF(2⁸).

The steps SubBytes 4, ShiftRows 6, and MixColumns 8 are independent of the particular key used. The key is applied in the step AddRoundKey 2. Except for the step ShiftRows 6, the processing steps can be performed on each column of the 4×4 state matrix without knowledge of the other columns. Therefore, they can be regarded as 32-bit operations as each column consists of 4 8-bit values. Dashed line 10 indicates that the process is repeated until the required number of rounds has been performed.

Each of these steps or a combination of steps may be represented by a lookup table or by a network of lookup tables (S-boxes). It is also possible to replace a full round of AES by a network of lookup tables. For example, the AddRoundKey step can be implemented by simply XOR'ing with the round key, while the SubBytes, ShiftRows, and MixColumns steps are implemented using table lookups. However, this means that the key is still visible to the attacker in the white-box attack context. The AddRoundKey step can also be embedded in the lookup tables, which makes it less obvious to find out the key.

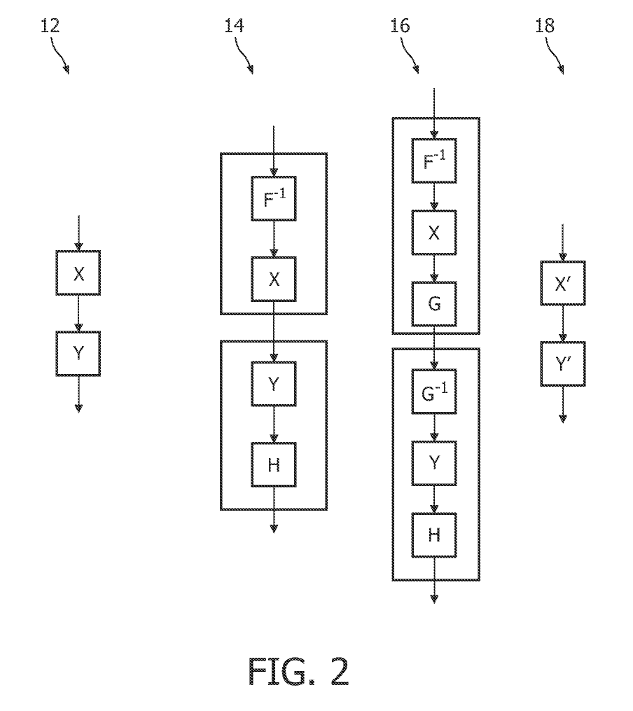

FIG. 2 illustrates a way to make it even more difficult to extract the key. Let X and Y be two functions. Consider an operation Y∘X(c)=Y(X(c)), illustrated as diagram 12 in FIG. 2, where c is an input value, for example a 4-byte state column. However, the approach applies to any type of input value c. Mappings X and Y can be implemented as look-up tables which can be stored in memory, however, when they are stored in memory the values can be read by an attacker. Diagram 14 illustrates how the contents of the look-up tables can be obfuscated by using an input encoding F and an output encoding H. Look-up tables corresponding to X∘F⁻¹ and H∘Y are stored as illustrated instead of X and Y, making it more difficult to extract X and Y. Diagram 16 shows how to add an additional, for example random, bijective function G, such that the intermediate result of the two tables is also encoded. In this case, two tables are stored in memory: X′=G∘X∘E⁻¹ and Y′=H∘Y∘G⁻¹. This is illustrated once more in diagram 18:

Y′∘X′=(H∘Y∘G⁻¹)∘(G∘X∘F⁻¹)=H∘(Y∘X)∘F⁻¹,

where ∘ denotes function composition as usual (i.e., for any two functions ƒ(x) and g(x), ƒ∘g(x)=ƒ(g(x)) by definition), X and Y are functions suitable for implementation by means of look-up tables. Likewise a network consisting of more than two functions can be encoded. The actual tables encoding X and Y are obfuscated by combining H∘Y∘G⁻¹ in a single look-up table and combining G∘X∘F⁻¹ in a single look-up table. As long as F, G, and/or H remain unknown, the attacker cannot extract information about X and/or Y from the look-up tables, and hence the attacker cannot extract the key that is the basis for X and/or Y. Other cryptographic algorithms, including DES and Rijndael (of which AES is a particular instantiation), may also be encoded as a (cascade or network of) look-up tables that may be obfuscated in a way similar to the above. This also holds for ciphers based on for example substitution-permutation networks or Feistel networks. The invention is not limited to the exemplary cryptographic algorithms mentioned.

Chow 1 discloses a method with the intend to hide the key by encoding its tables with random bijections representing compositions rather than individual steps. Preventing secret-key extraction has the advantage that an attacker is prevented from extracting keying material which would allow software protection goals to be bypassed on other machines, or from publishing keying material effectively creating ‘global cracks’ which defeat security measures across large user-bases of installed software. It provides an increased degree of protection given the constraints of a software-only solution and the hostile-host reality. In the approach of Chow 1, the key is hidden by (1) using tables for compositions rather than individual steps; (2) encoding these tables with random bijections; and (3) extending the cryptographic boundary beyond the crypto algorithm itself further out into the containing application, forcing attackers (reverse engineers) to understand significantly larger code segments to achieve their goals. Chow 1 discusses a fixed key approach: the key(s) are embedded in the implementation by partial evaluation with respect to the key(s), so that key input is unnecessary. Partial evaluation means that expressions involving the key are evaluated as much as reasonably possible, and the result is put in the code rather than the full expressions. The attacker could extract a key-specific implementation and use it instead of the key, however cryptography is typically a component of a larger containing system that can provide the input to the cryptographic component in a manipulated or encoded form, for which the component is designed, but which an adversary will find difficult to remove. Referring to the step of encoding tables, since encodings are arbitrary, results are meaningful only if the output encoding of one step matches the input encoding of the next. For example, if step X is followed by step Y (resulting in computation of Y∘X), the computation could be encoded as

Y′∘X′=(H∘Y∘G⁻¹)∘(G∘X∘F⁻¹)=H∘(Y∘X)∘F¹.

This way, Y∘X is properly computed albeit that the input needs to be encoded with F and the output needs to be decoded with H⁻¹. The steps are separately represented as tables corresponding to Y′ and X′, so that F, G, and H are hidden as well as X and Y.

Apart from such confusion steps, Chow 1 uses diffusion steps by means of linear transformations to further disguise the underlying operations. The term mixing bijection is used to describe a linear bijection, used in the above sense. The implementation of Chow 1 takes input in a manipulated form, and produces output in a differently manipulated form, thereby making the white-box attack context (WBAC) resistant AES difficult to separate from its containing application.

A White-box AES implementation can be sketched as follows. The input to the AES encryption and decryption algorithm is a single 128-bit block. This block is represented by a 4×4 matrix consisting of 16 bytes. AES usually consists of 10 rounds for AES-128. Each round updates a set of sixteen bytes which form the state of AES, thus each AES round processes 128 bits. AES-128 uses a key of 128 bits. This key serves as input for an algorithm which converts the key into different round keys of 128 bits. A basic round consists of four parts:
SubBytes
ShiftRows
MixColumns
AddRoundKey.

This order of operations applies to AES encryption. Although the standard order of operations in AES decryption is different, it is possible to rewrite the AES decryption algorithm to have the same order of operations as for AES encryption.

Before the first round, an extra AddRoundKey operation occurs, and in round ten the MixColumns operation is omitted. The only part that uses the key is AddRoundKey, the other three parts do nothing with the key. In the implementation the boundaries of the rounds are changed to integrate the AddRoundKey step and the SubBytes step of the next round into one step. A round begins with AddRoundKey and SubBytes followed by ShiftRows and finally MixColumns.

First, the key is hidden by composing the SubBytes step and the AddRoundKey together into one step. This makes the key no longer visible on its own. Because the key is known in advance, the operations involving the key can be pre-evaluated. This means that the standard S-Boxes which are used in the step SubBytes can be replaced with key-specific S-Boxes. To generate key-specific instances of AES-128, the key is integrated into the SubBytes transformations by creating sixteen 8×8 (i.e. 8-bit input, 8-bit output) lookup tables T_{i,j}^{r} which are defined as follows:

T_{i,j}^{r}(x)=S(x⊕k_{i,j}^{r-1}), i=0, . . . , 3; j=0, . . . , 3; r=1, . . . , 9,

where S is the AES S-box (an invertible 8-bit mapping), and k_{i,j}^{r} is the AES sub-key byte at position i, j of the 4×4 matrix which represents the round key for round r. These T-boxes compose the SubBytes step with the previous round's AddRoundKey step. The round 10 T-boxes absorb the post-whitening key as follows:

T_{i,j}¹⁰(x)=S(x⊕k_{i,j}⁹)⊕k_{sr(i,j)}¹⁰, i=0, . . . , 3; j=0, . . . , 3,

where sr(i,j) denotes the new location of cell i, j after the ShiftRows step. The total number of T-boxes is 10×16=160. However, the key can easily be recovered from T-boxes because S⁻¹ is publicly known. This makes additional encodings necessary. Linear transformations are used for diffusing the inputs to the T-boxes. These linear transformations are called mixing bijections and can be represented as 8×8 matrices over GF(2). The mixing bijections are inverted by an earlier computation to undo their effect.

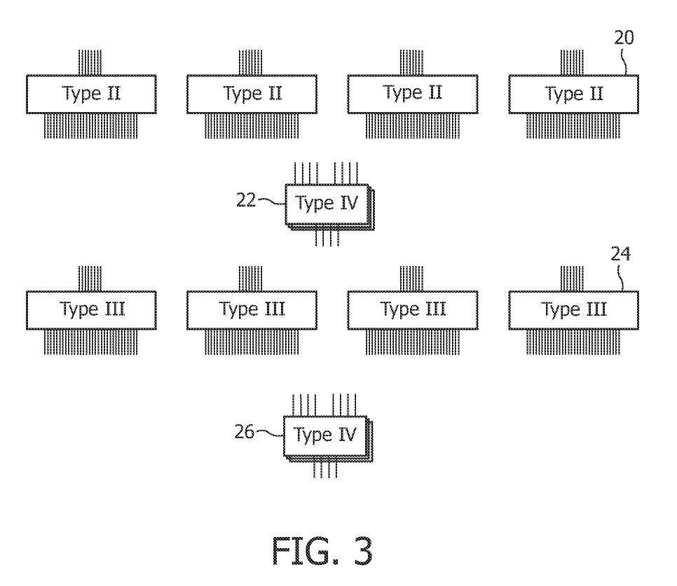

FIG. 3 illustrates the tables involved in a round of white-box AES for one 32-bit column of the state (after applying ShiftRows). The names of the different types of tables are introduced here. They are discussed in more detail hereinafter. Before the rounds, each byte of the 128-bit state is applied to a respective type Ia table. This results in respective 128-bit values which are XOR'ed using a network of type IV tables to provide a 128-bit output that is divided into four 32-bit values. Now, the first round starts. The processing steps of each 32-bit value are outlined here. The four bytes of the 32-bit value are input to four respective type II tables 20. Each of the four type II tables 20 result in a 32-bit output. These outputs are bitwise XOR'ed using type IV tables 22. Each type IV table 22 performs a 4-bit bitwise XOR. By properly connecting inputs and outputs of type IV tables, the bitwise XOR of the four 32-bit outputs can be realized as will be understood by the skilled artisan. The result of this step is a 32-bit value. Each of the four bytes of this value is applied to a respective type III table 24. Each type III table provides a 32-bit output. These outputs are again bitwise XOR'ed using a network of type IV tables 26 similar to the network of type IV tables 22. The output is a 32-bit value indicative of a column of the state. Round 2 to 9 are similar to this first round. Each byte of the 128-bit value is applied to a type Ib table; the results are XOR'ed using a network of type IV tables. The last round (usually the tenth round) may be absorbed by the external encoding.

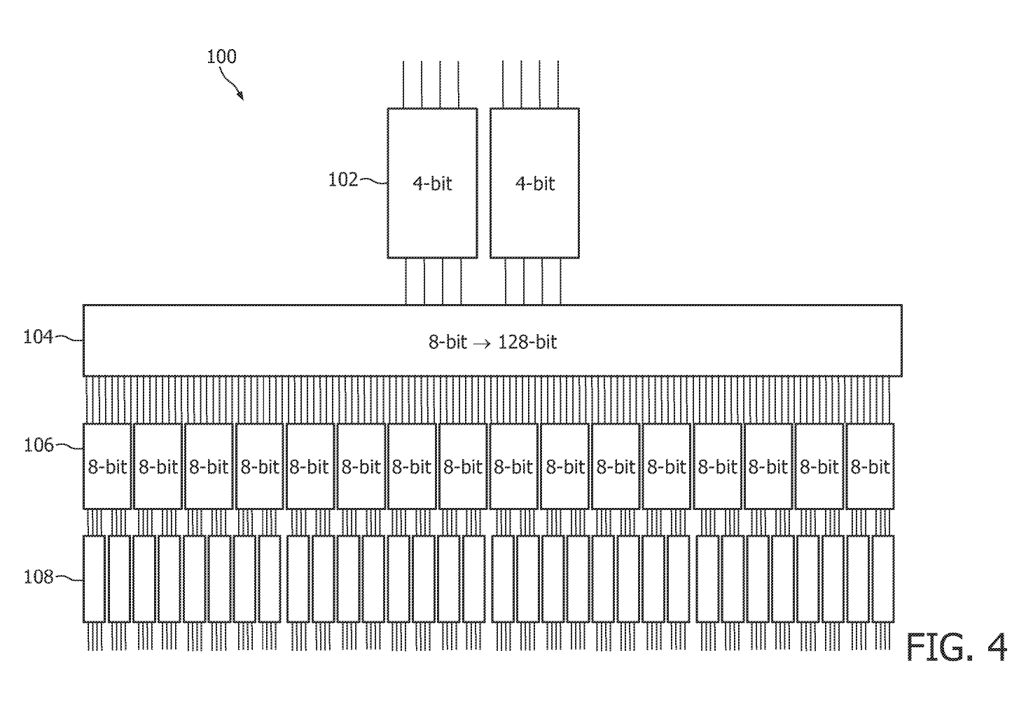

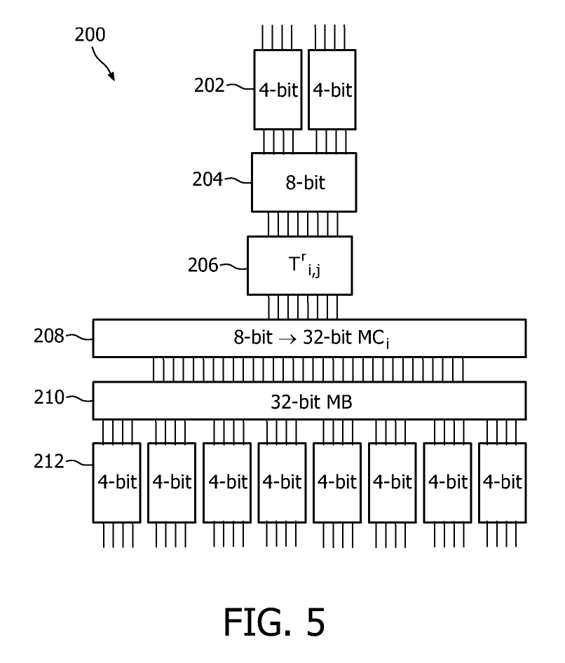

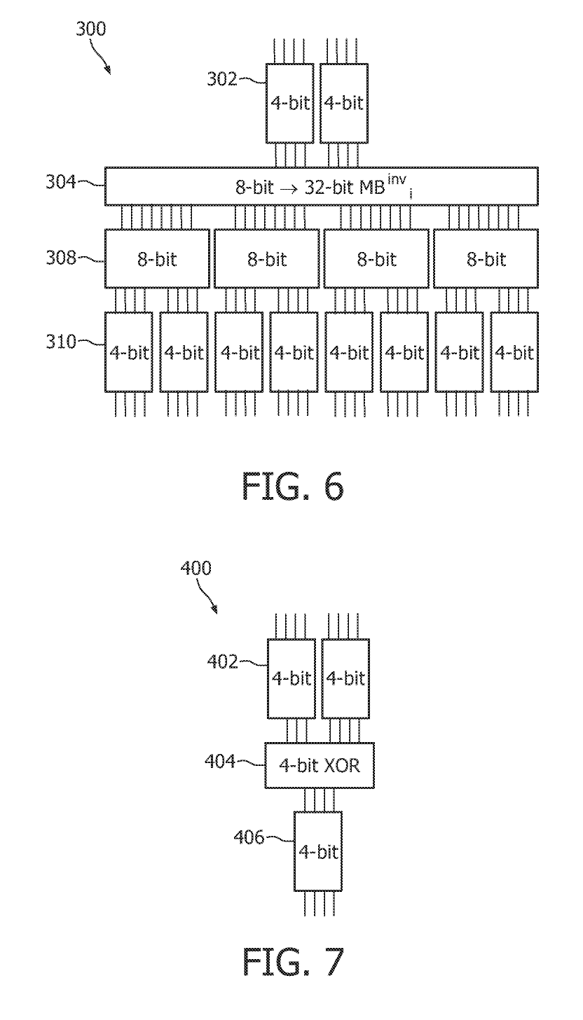

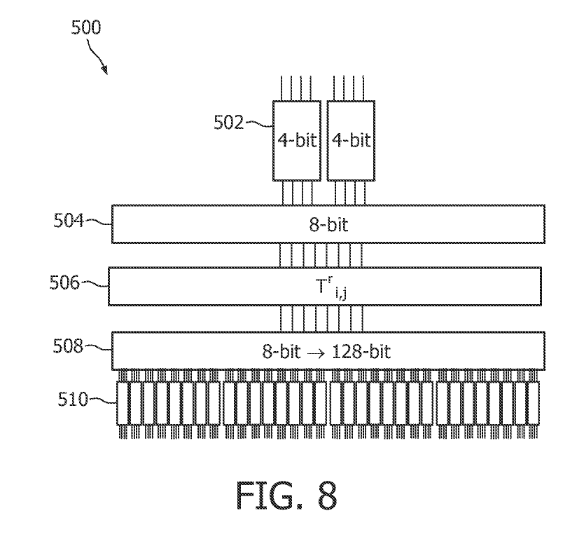

FIG. 4 illustrates a type Ia table 100. FIG. 5 illustrates a type II table 200. FIG. 6 illustrates a type III table 300. FIG. 7 illustrates a type IV table 400. FIG. 8 illustrates a type Ib table 500.

The mixing bijections are used as follows. An AES state is represented by a 4×4 matrix consisting of bytes. The MixColumns step operates on a column (four 8-bit cells) at a time. Consider a 32×32 matrix MC. If this is represented by a table, this table would cost 2³²×32=137438953472 bits=16 GB. In order to avoid such large tables the matrix is blocked into four sections.

MC is blocked into four 32×8 sections, MC₀, MC₁, MC₂, MC₃ (block 208). Multiplication of a 32-bit vector x=(x₀, . . . , x₃₁) by MC is done by dividing the bits of x into four bytes and multiplying each of the sections of MC with one of the bytes, yielding four 32-bit vectors (z₀, . . . , z₃). This is followed by three 32-bits XORs giving the final 32-bit result z. The four tables together only cost 4×2⁸×32=32768 bits=4 KB.

The three XORs will be divided into 24 4-bit XORs, each represented by a possibly encoded look-up table, with appropriate concatenation (e.g. ((z[0, 0], z[0, 1], z[0, 2], z[0, 3])+(z[1, 0], z[1, 1], z[1, 2], z[1, 3]))∥((z[0, 4], z[0, 5], z[0, 6], z[0, 7])+(z[1, 4], z[1, 5], z[1, 6], z[1, 7]))∥ . . . ), where ∥ denotes concatenation and + denotes XOR. By using these strips and subdivided XORs, each step is represented by a small lookup table. In particular, for i=0, . . . , 3 the zᵢ are computed using 8×32 tables, while the 4-bit XORs become 24 8×4 tables. FIG. 7 illustrates how input decodings 402 and output encodings 406 can be put around the XORs 404. These encodings are usually randomly chosen non-linear 4×4 bijections. The XOR tables are called type IV tables 400. The type IV tables take as input 4 bits from each of two previous computations. The output encodings 212 of those computations are matched with the input decodings 402 for the type IV tables to undo each other. The choice for 4×4 non-linear bijections depended on the size of the tables. In this situation a type IV table is only 2⁸×4 bits=128 bytes. 24 tables are needed which cost together 3 KB. If the XORs were not divided, three XOR tables would be needed which computed 32-bit XORs. The T-boxes 206 and the 8×32 tables 208 could be represented as separate lookup tables. Instead, they can be composed creating new 8×32 tables 200 computing the SubBytes and AddRoundKey transformations as well as part of MixColumns. This saves both space (to store the T-boxes) and time (to perform the table lookups).

Before splitting MC into MCᵢ as above, MC will be left-multiplied by a 32×32 mixing bijection MB, illustratively indicated in FIG. 5 at reference numeral 210, chosen as a non-singular matrix with 4×4 sub-matrices of full rank. The use of mixing bijections increases the number of possible constructions for a particular table.

FIG. 5 illustrates an 8×32 type II table 200 including 4×4 input decodings 202 and 4×4 output encodings 212. These output encodings and input decodings are non-linear 4×4 bijections which must match the input decodings and output encodings of the type IV tables 400. The type II tables 200 are followed by type IV tables 400. In order to invert MB, an extra set of tables is used for calculating MB⁻¹. Let (x′₀, . . . , x′₃₁) be the input to MixColumns, and let (z₀, . . . , z₃₁) be the output after MixColumns. Let (z′₀, . . . , z′₃₁)^{T} be the result after multiplication with MB. (z′₀, . . . , z′₃₁)^{T} serves as input to the type III tables 300. Note that the input decodings and the output encodings need not be considered here because the output encoding of a table is undone by the input decoding of a next table. In the type III tables 300, MB⁻¹ is applied 304 and the inverses 308 of the four input mixing bijections 204 of the next round's four type II tables 200.

FIG. 6 illustrates an 8×32 type III table 300 including 4×4 non-linear input decodings and 4×4 non-linear output encodings. These tables are followed by corresponding type IV tables 400.

One round of data operations involves an operation on a 128-bit state matrix. The data operations performed on each of four strips of 32 bits of the 128-bit state matrix is as follows. The 32-bit strip is divided into four 8-bit bytes. Each of the four bytes is fed into a distinct type II table 200, resulting in four 32-bit output values. These values have to be XOR'ed using obfuscated type IV tables 400. To that end, each 32-bit output value is divided into eight 4-bit nibbles, and appropriate pairs of nibbles are input to respective type IV tables, such that the XOR of the four 32-bit output values is obtained in encoded form.

This 32-bit resulting encoded XOR'ed result is again divided into bytes, and each byte is input to a distinct type III table 300. The input decoding of each nibble of the type III tables corresponds to the output encoding of the last applied type IV tables. The type III tables again result in four 32-bit output values that are again XOR'ed using obfuscated type IV tables 400.

In summary, the rounds are implemented by lookup tables. The lookup tables of a single round are networked as follows. The data is fed into Type II tables. The output of these tables is fed to a network of Type IV tables representing encoded XORs. The output of this network is fed to Type III tables canceling the mixing bijection encoding that is inserted by the Type II tables. The encoded output of the round is finally derived by feeding the output of the Type III tables into, again, a network of Type IV tables representing encoded XORs.

Furthermore, the white-box implementation contains Type I tables at the beginning (type Ia table 100) and the end (type Ib table 500) for respectively canceling out and inserting external encodings. The type Ia table 100 can be used to apply a concatenation of mappings as illustrated in FIG. 4 by applying a single table look-up. In the concatenation, a 4-bit nibble input decoding 102 appears first. Then, an 8-bit to 128-bit bijection 104 appears; this bijection effectuates an encoding of the input and output of the network; this mapping can be undone elsewhere in the program. The result of bijection 104 is split in 16 eight-bit pieces to which respective 8-bit bijections 106 are applied. Finally, the output nibble encoding 108 is applied. As mentioned, the cascade of mappings 102, 104, 106, and 108 is pre-evaluated and the final result is tabulated in a look-up table. This results in a table with at most 256 entries of 128 bits each. The concatenation of mappings incorporated in a type Ib table 500 is schematically displayed in FIG. 8. The first mapping is the input nibble decoding 502, which is followed by an 8-bit bijection 504, a T-box T^{r}_{i,j} 506, where r corresponds to the last round, an 8-bit to 128 bit mapping for providing output encoding, and output nibble encodings 510. The 128-bit output of this kind of table is XOR'ed with the output of other type Ib tables, again making use of nibble input and output encoded type IV tables 400. The output encoding 508 is undone elsewhere in the program, i.e., outside the cryptographic part of the program. This makes it more difficult for an attacker to break the encodings of the tables by analyzing only an input and an output of the cryptographic part of the program.

White-box cryptography involves implementing a block cipher in software, such that an attacker cannot even extract the key in the white-box attack model. The white-box attack model is among the strongest conceivable attack models, because the attacker is assumed to have full access to the implementation and full control over the execution environment. White-box implementations exist for AES, DES, and other encryption schemes. These white-box implementations are based on similar ideas set forth above, and a skilled person is able to apply the principles of white-box implementations to create white-box implementations of other cryptographic schemes.

Recently, some attacks have been published that reveal some weaknesses of particular white-box implementations. For example, Billet describes an attack against a white-box implementation of AES. A need arises for an improved block cipher that has properties to make such attacks more difficult in a white-box context. Applications of white-box implementations, such as enhancing the tamper resistance of software, would benefit from such an improved block cipher. That is, they would benefit from a block cipher for which a white-box implementation exists that is both secure and has a good performance in terms of speed and storage.

Block ciphers such as AES and DES have some disadvantages when used in a white-box implementation. This is also reflected by the attacks that have been published on their white-box implementations. Although patches exist for the attacks that have been published so far, it would be preferable to have a fit-to-purpose block cipher that does not have the weaknesses, or at least reduces some of the weaknesses, of the known block ciphers.

The diffusion operator of block ciphers can usually be specified as a fixed matrix multiplication. This is, for instance, the case for AES and DES. White-box implementations of such a block cipher, where the block cipher includes a fixed linear diffusion operator, may be vulnerable to an attack as described in Billet. This is explained hereinafter.

A white-box implementation as set forth comprises lookup tables that are obfuscated by encoding their input and output. In Chow 1 and Chow 2 it is proposed to use non-linear encodings. However, in view of the attack described in Billet, one may argue that the non-linear part of the encodings do not sufficiently obfuscate the key, and that the linear operator occurring in the underlying cryptographic scheme remains a weakness in the white-box implementation. It is proposed to make the choice of the linear operator variable, for example by making the definition of the linear operator part of the key.

In an embodiment, AES is modified such that the diffusion operator is a variable. A diffusion operator of AES is MixColumns. This operation transforms four bytes a0, a1, a2, a3 into four bytes b0, b1, b2, b3, via the matrix multiplication

$$[ \begin{matrix}{b}_{0} \\ {b}_{1} \\ {b}_{2} \\ {b}_{3}\end{matrix} ] = ( \begin{matrix}02 & 03 & 01 & 01 \\ 01 & 02 & 03 & 01 \\ 01 & 01 & 02 & 03 \\ 03 & 01 & 01 & 02\end{matrix} ) [ \begin{matrix}{a}_{0} \\ {a}_{1} \\ {a}_{2} \\ {a}_{3}\end{matrix} ] , \qquad ( 1 )$$

where the elements of the matrix are given in hexadecimal notation. The matrix can be made variable by including its definition in the key, where the matrix elements are replaced by different values. In AES, the key is formed by a 128-bit string that is used in the AddRoundKey transformation. In the modified version according to this embodiment, it is a combination of this 128-bit string and the coefficients used in the MixColumns transformation. It is possible to use one set of coefficients to represent a single MixColumns transformation that should be used to replace Equation (1) throughout the cryptographic scheme. Because an attacker does not know which transformation is used, and because different keys including different unknown transformations are distributed, it is more difficult to design an efficient attack. It is also possible to use more sets of coefficients each representing a different MixColumns transformation. In this case, different MixColumns transformations are used in different places in the cryptographic scheme, which further complicates an attack. For example, different transformations are applied in different rounds and/or to different columns.

The block cipher may be implemented by means of a white-box implementation. Such a white-box implementation comprises the (key-dependent) MixColumns operation in the form of encoded look-up tables. When the key (including a definition of a modified MixColumns operation) needs to be updated or changed, a new set of look-up tables needs to replace (some of) the existing look-up tables. To this end new coefficients may be provided to the white-box implementation in a possibly encoded or encrypted form.

The methods set forth may be applied to obtain a secure white-box implementation of a block cipher. This white-box implementation can be used to protect the key of a block cipher (this is a common objective of white-box cryptography), but also to apply related software tamper resistance techniques.

It should be noted that the operations performed in a white-box implementation may be divided into two types. The first type of operations are part of a cryptographic scheme underlying a white-box implementation. Roughly these operations may be recognized by the fact that they determine the values in the encrypted data. The second type of operations, which may be referred to as ‘encodings’, are included in the white-box implementation to obfuscate the intermediate results of first type operations. Usually an output of an operation of the first type is encoded by means of an output encoding. This output encoding is undone before applying the next operation of the first type by a corresponding input decoding operation. Usually, one or more input decodings, one or more operations of the first type, and one or more output encodings are combined in a single operation, usually a look-up table, so that it is difficult to extract information about the first type operation by inspecting the code or by performing other white-box attacks.

One conclusion that may be drawn from the attacks that have been published is that the input and output encodings do not sufficiently hide the operations of the first type. This is especially the case if a number of transformations of the first type are publicly known information, and only a few operations or even only a single operation is variable, or key dependent. For example, AES includes four operations in a round. Only one operation is key dependent (the AddRoundKey step performs an XOR operation with bits derived from the key). The three remaining operations (SubBytes, ShiftRows, and MixColumns) are completely fixed in the specification of the standard. This makes it relatively easy to break the operations of the second type, i.e., the input and output encodings surrounding these operations. One step making the white-box implementation vulnerable to an attack is the MixColumns step. This step is recognized as a diffusion operation, because it ensures that a bit error introduced during the decryption is propagated (diffused) over 32 output bits, i.e. multiple bytes, whereas the SubBytes step (S-boxes) operates on single bytes. Consequently the white-box implementation can be better protected against attacks by using, instead of AES, a modification of AES in which the MixColumns step is governed by a secret matrix. This secret matrix may be hard-coded into the white-box implementation or may be communicated by providing enough information about the matrix (e.g. a new set of look-up tables) to enable the white-box implementation to apply the MixColumns step to the data.

Care may be taken to ensure that the, now variable, diffusion operator satisfies certain desirable properties. These desirable properties include that the diffusion operator is invertible. Also, a change of one (or a few) bits in the input of the operator should have an effect on many of the output bits of the operator. More precisely, given two input values x and y, the sum of the number of bits that are different in x and y and the number of bits that are different in the output values corresponding to x and y should be large. In particular, the minimal value of this sum when considering all combinations of input values x and y should be large. For example this can be realized by using a diffusion operator that is maximum distance separable. It is also possible to use a non-linear diffusion operator to make the system even more difficult to break. A simple way to enforce the desired properties is to choose a random operator within a large class of operators, and verifying whether the chosen operator belongs to a smaller class of operators having the desired properties. If the verification shows that the chosen operator does not belong to the smaller class of operators, a new random operator is chosen from the large class of operators and verified, until an operator is found that does belong to the smaller class of operators.

Another desirable property of such a diffusion operator is outlined in the following. Consider a block cipher of which a rounds consists of S-boxes followed by a matrix multiplication with a matrix M that handles the diffusion. Furthermore, suppose that we implement this block cipher by a white-box implementation. Let n denote the number of input bits of an S-box and let m be the granularity of the non-linear output encodings of a round, i.e., the output of a round is encoded by m-bit non-linear functions (for the exemplary white-box AES implementation set forth, n=8 and m=4). Define bᵢ as the output of the i^{th} S-box, k as the number of S-boxes, and/as the number of encoded output words (note that this implies that the input size and output size of the diffusion operator is given by kn=lm bits), then the output of a round is given by

$$M ( \begin{matrix}{b}_{1} \\ {b}_{2} \\ ⋮ \\ {b}_{k}\end{matrix} ) = ( \begin{matrix}{x}_{1} \\ {x}_{2} \\ ⋮ \\ {x}_{l}\end{matrix} ) ,$$

where bᵢ is an n-bit value for all i=1, . . . , k, and xᵢ is an m-bit value for all i=1, . . . , l. Define M_{i,j} as the m×n submatrix of M that starts at row (i−1)m and column (j−1)n, where the rows and columns are counted from 0 onwards, then the above expression can be rewritten as

$$( \begin{matrix}{M}_{11} & {M}_{12} & … & {M}_{1 k} \\ {M}_{21} & {M}_{22} & … & {M}_{2 k} \\ ⋮ & ⋮ & ⋮ & ⋮ \\ {M}_{l 1} & {M}_{l 2} & … & {M}_{lk}\end{matrix} ) ( \begin{matrix}{b}_{1} \\ {b}_{2} \\ ⋮ \\ {b}_{k}\end{matrix} ) = ( \begin{matrix}{x}_{1} \\ {x}_{2} \\ ⋮ \\ {x}_{l}\end{matrix} ) .$$

Consider one row of k submatrices Mᵢ₁, Mᵢ₂, . . . , Mᵢₖ in M. Let subset V={vᵢ, v₂, . . . , vᵣ} be a subset of these matrices for some positive integer r. Define M(V) as the m×nr matrix obtained by concatenating the matrices in V, i.e., for some positive integer p, row p of M(V) is obtained by sequencing the p^{th} row of all matrices from V. For instance, for

$$V = \{ ( \begin{matrix}1 & 0 \\ 0 & 1\end{matrix} ) , ( \begin{matrix}1 & 1 \\ 0 & 0\end{matrix} ) \}$$

the matrix M(V) is given by

$$M ( V ) = ( \begin{matrix}1 & 0 & 1 & 1 \\ 0 & 1 & 0 & 0\end{matrix} ) .$$

The desirable property of a diffusion operator is that for any i=1, . . . , l, row i of submatrices Mᵢ₁, Mᵢ₂ . . . , Mᵢₖ in M, there do not exist two disjoint subsets V₁ and V₂ of {Mᵢ₁, Mᵢ₂, . . . , Mᵢₖ}, such that M(V₁) and M(V₂) both have a rank of m.

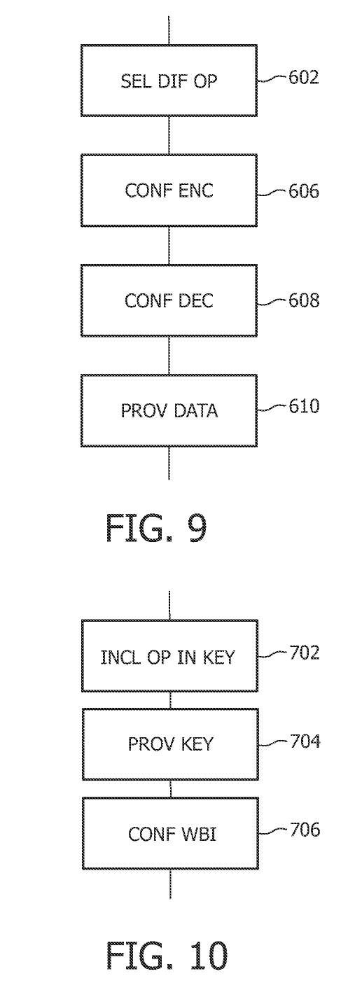

FIG. 9 shows a flowchart illustrating processing steps according to an embodiment of the invention. In step 602, a diffusion operator is selected randomly to be part of a key to a block cipher. The randomization may be realized using a (pseudo-)random generator. It may also be realized by a more or less random human input. A sequential selection, in which the selected operators are assigned to different users in an essentially random order also is a random selection. The class of operators may be defined by means of a set of formulas having parameters that are filled in by means of the random generator. In step 606, an implementation of an encryption algorithm is configured according to the key of step 602. This comprises setting the diffusion operator to the value specified by the key. Thus, the diffusion operator is given its place in the block cipher. In step 608, an implementation of a decryption algorithm corresponding to the encryption algorithm is configured according to the key. This may be done in a way similar to the configuring of the implementation of the encryption algorithm. Where appropriate, the diffusion operator should be inverted in either of the two implementations, according to the block cipher.

At least one of the two implementations is a white-box implementation. With regards to the configuring of the white box implementation, the diffusion operator may not be communicated explicitly to the white box implementation for security reasons. Instead, it may be obfuscated by properly selected input and/or output encodings. The look-up tables representing the obfuscated diffusion operator may then be communicated to the white-box implementation, thereby implicitly enabling it to use the key. The look-up tables may also be combined with one or more other operations of the cryptographic algorithm. The diffusion operator may also be split up into several smaller operations. Usually, in the white-box implementation, these obfuscated operations will be implemented by means of look-up tables.

In step 610, the two implementations are used for exchange of encrypted data. To that end, data encrypted by the implementation of the encryption algorithm is transferred to the implementation of the decryption algorithm. Usually, the two implementations will be used on different terminals. The data exchange may be realized using an internet connection or other type of network connection, but also by means of a storage medium such as a CD or DVD.

The operations have been presented in this and other embodiments in a particular order. This is to be regarded as an example only, as the skilled person will recognize that the steps may be performed in many different orders.

FIG. 10 illustrates an embodiment of the invention. It shows in step 702 that a cryptographic key message is generated including information relating to the selected diffusion operator. This message should contain sufficient information for the white-box implementation to appropriately configure itself. Usually the message does not contain the diffusion operator explicitly, but rather it contains a version of the diffusion operator provided with input and output encodings. The cryptographic key message may be partly or completely encrypted. The message may contain further key information, for example if an AES-like block cipher is used, the key may also contain a 128-bit AES key. In step 704 the cryptographic key message is provided to the white-box implementation using any known medium such as a digital network or a digital storage medium. In step 706, the white-box implementation is configured in dependence on the information in the message. For example, if the key contains the diffusion operator in the form of look-up tables, these look-up tables are included in the white-box implementation in a predetermined way. The terminal on which the white-box implementation resides has software and/or hardware capable of receiving and processing the cryptographic key message to configure the white-box implementation.

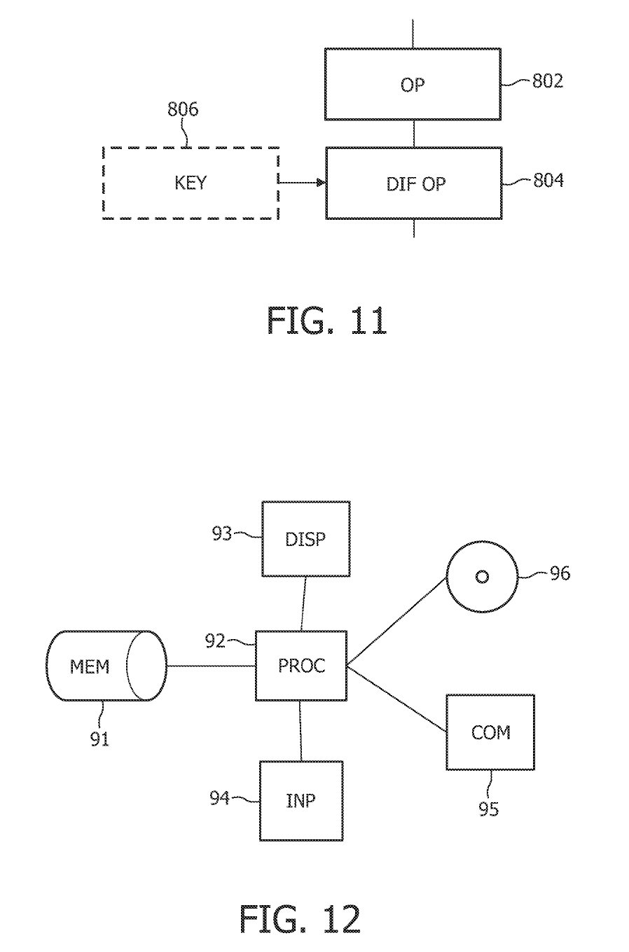

FIG. 11 illustrates a cryptographic method. The cryptographic method is suitable for being implemented in a white-box implementation. The method involves applying a plurality of transformations (block 802) each replacing an input word by an output word. In the example based on AES, such transformations include AddRoundKey, SubBytes, and ShiftRows (which replaces an input word by a neighboring input word in the row). These operations have in common that the information in each byte is not propagated to more than one other byte.

The method further involves applying a diffusion operator (block 804) to a concatenation of a plurality of the output words. The diffusion operator has the effect that it diffuses information represented by the output words among the output words. In the example of AES, such a diffusion operator is MixColumns, as MixColumns propagates the information in a byte among the bits of a 32-bit string which is a concatenation of four bytes. Information representing the diffusion operator is included in a key 806 to the cryptographic method. This key makes the diffusion operator a variable of the method.

FIG. 12 illustrates an embodiment of the invention. The Figure shows a communication port 95 such as a connection to the Internet for connecting with a provider of digital content. The content can also be obtained from medium 96 such as a DVD or CD. Digital content on the PC is typically rendered using media players being executed by processor 92 using memory 91. Such players can execute, for a specific content format, a respective plug-in for performing the format-specific decoding corresponding to content obtained via communication port 95 and/or medium 96. Those content formats may include AVI, DV, Motion JPEG, MPEG-1, MPEG-2, MPEG-4, WMV, Audio CD, MP3, WMA, WAV, AIFF/AIFC, AU, etc. For digital rights management purposes, a secure plug-in may be used that not only decodes the content but also decrypts the content. This plug-in comprises processor instructions and parameters (such as obfuscated look-up tables) stored in memory 91. The obfuscated look-up tables form a white-box implementation with a randomly selected diffusion operator as set forth. Optionally cryptographic key messages may be received via communication port 94 and/or medium 96. A user input 94 may be provided to obtain commands from a user to indicate content to be rendered, and display 93 and/or speakers are provided for rendering the decoded and/or decrypted content.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A cryptographic method for being implemented in a white-box implementation thereof, the method comprising
applying a plurality of transformations (802) each replacing an input word by an output word; and
applying a diffusion operator (804) to a concatenation of a plurality of the output words for diffusing information represented by the output words among the output words;
wherein a key (806) to the cryptographic method comprises information representing the diffusion operator.

2. The method according to claim 1, wherein the diffusion operator satisfies a property that a change of one bit in an input to the diffusion operator corresponds to a change of more than one bit in an output of the diffusion operator.

3. The method according to claim 1, wherein the diffusion operator is a nonlinear operator.

4. The method according to claim 1, wherein
an input of the diffusion operator is given by a sequence of k outputs of S-boxes, the output of each S-box being an n-bit value, where k and n are predetermined positive integer values,
an output of the diffusion operator represents a sequence of l inputs to non-linear output encodings of the white-box implementation, the input to each output encoding being an m-bit value, where l and m are predetermined positive integer values, and
the diffusion operator is a linear operator having a representation as an invertible matrix dividable into l rows of k submatrices of m×n elements, each row satisfying a property that a matrix formed by a concatenation of a first subset of the submatrices forming that row and a matrix formed by a concatenation of a second subset of the submatrices forming that row, the first subset and the second subset being disjunct, do not both have a rank of m.

5. The method according to claim 1, wherein the key comprises a representation of the invertible matrix.

6. The method according to claim 1, wherein the cryptographic method comprises a Rijndael method in which a MixColumns operator is replaced by the diffusion operator.

7. A system comprising
an input for receiving a key, the key comprising information representing a diffusion operator; and
a white-box implementation of a cryptographic method, the cryptographic method comprising applying a plurality of transformations each replacing an input word by an output word; and applying the diffusion operator to a concatenation of a plurality of the output words for diffusing information represented by the output words among the output words.

8. The system according to claim 7, wherein the key comprises one or more look-up tables representing the diffusion operator obfuscated with input and output encodings.

9. A client-server system comprising
a client comprising an input for receiving a key, the key comprising information representing a diffusion operator; the client further comprising a white-box implementation of a cryptographic method, the cryptographic method comprising applying a plurality of transformations each replacing an input word by an output word, and applying the diffusion operator represented by the information in the key to a concatenation of a plurality of the output words for diffusing information represented by the output words among the output words;
a server for applying a cryptographic method corresponding to the cryptographic method implemented in the client, in dependence on the key; and
means for generating the key.
